(19) United States
(12) Patent Application Publication
(10) Pub. No.: US 2010/0038964 A1
(43) Pub. Date: Feb. 18, 2010

(54) Method for Supplying Energy to a Field Device in Automation Technology

(76) Inventors: Thomas Budmiger, Ettingen (CH); Jorg Roth, Lorrach (DE); Mike Touzin, Steinen (DE); Dieter Waldhauser, Kempten (DE); Torsten Iselt, Kempten (DE)

Correspondence Address: BACON & THOMAS, PLLC, 625 SLATERS LANE, FOURTH FLOOR, ALEXANDRIA, VA, 22314-1176, US

(21) Appl. No.: 11/991,502

(22) PCT Filed: Sep. 1, 2006
(86) PCT No.: PCT/EP2006/065936

§ 371 Date: May 5, 2009

(51) Int. Cl. H02J 7/34; H02J 1/00

(52) U.S. Cl. 307/66; 307/154

(57) ABSTRACT

A method for supplying energy to a field device of process automation, which servers for registering a chemical and/or physical property of a process medium, energy required for operating the field device is obtained by means of the process medium.

In automation technology, field devices are often used to register and/or influence process variables. Examples of registering field devices include fill level measuring devices, mass flow measuring devices, pressure and temperature measuring devices, pH- and conductivity-measuring devices, etc., which, as sensors, register the corresponding process variables, fill level, flow rate, pressure, temperature, pH-value, and conductivity.

Actuators serve as field devices for influencing process variables. Examples of such field devices include valves controlling flow rate of a fluid in a section of piping and pumps controlling fill level in a container.

Logging devices, which are also field devices, record measurement data on-site.

A large number of such field devices are produced and sold by the firm, Endress+Hauser.

Field devices in modern automated plants are normally connected via fieldbus systems (HART, Profibus, Foundation Fieldbus, etc.) to superodinated units (e.g. control systems or control units), in order to exchange with data therewith, especially measurement data.

Supplying energy, or power, to a field device is accomplished either directly via the communications line (2-conductor devices, loop powered) or through an additional supply line (4-conductor devices). The cabling effort, especially in the case of the 4-conductor devices, is quite complex and expensive. In both cases, the energy needed to operate a field device is transferred via cable.

Frequently, the superordinated units are integrated into enterprise-wide networks. In this way, process- and/or field-device-data can be accessed from different areas of an enterprise. For worldwide communication, company networks can be connected with public networks, e.g. the Internet.

Recently, applications are also known in which field devices are no longer connected to wired, fieldbus systems, but, instead, the field devices transfer data via radio. For this, the field devices require a corresponding radio interface. This radio connection can also be embodied as a radio network.

An essential advantage of these radio field devices is that they need no connective wiring. As a result, they can be quickly and easily installed and put into use at any location.

Radio field devices are supplied either by battery, or by small, local, energy supply units. The energy supply unit can be e.g. a solar module or a fuel cell. The solar module has the advantage that it is relatively maintenance-free, but, in many applications, solar energy is not available or is limited by time of day. All other solutions require regular replacement of the energy carrier -- a task which can be very costly for the user.

Therefore, an object of the invention is to provide a method for supplying energy to a field device of automation technology, which method does not have the above-named disadvantages, and which, especially, ensures a maintenance-free supply of energy.

This object is achieved through features presented in claim 1.

Method for supplying energy to a process automation field device, which serves for registering or influencing a chemical and/or physical property of a process medium and which is controlled by a microprocessor, characterized in that energy required for operating the field device is obtained by means of the process medium.

An essential idea of the invention is that energy required for operating the field device is obtained by means of the process medium. Normally, process information is necessary only when the process medium concerned is present with its running process parameters. An example here is a superheated steam application, in which the quantity of steam flowing through a pipeline, per unit of time, is to be determined. Only when the steam is present and flowing in the pipeline is the corresponding measurement value necessary.

In a further development of the invention, the energy is obtained with the help of a thermogenerator, which exploits the difference between the temperature of the process medium and the ambient temperature of the field device.

Alternatively, it is also conceivable to exploit temperature differences in the process medium, such as those that can arise e.g. between supply and return.

Advantageously, the thermogenerator is a Peltier element. Such elements are very efficient and relatively cost-effective.

Recently, micro-Peltier elements have become available which, when arranged in arrays, produce a very high power output.

Serving as energy buffer is an energy storage unit, in which excess energy can be stored intermediately, to be used at times when relatively little energy can be obtained from the process medium, in order to sustain operation of the field device.

In a further development of the invention, an energy control unit is provided, which regulates energy distribution and energy consumption in the field device. If e.g. little energy is available and the energy storage unit is relatively empty, then energy consumption in the field device must be reduced accordingly.

The invention will now be described in greater detail on the basis of an example of an embodiment illustrated in the drawing, whose figures show as follows:

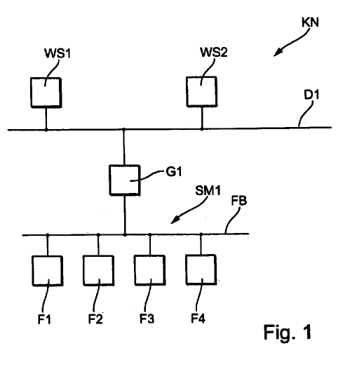

FIG. 1 schematic illustration of a network of automation technology;

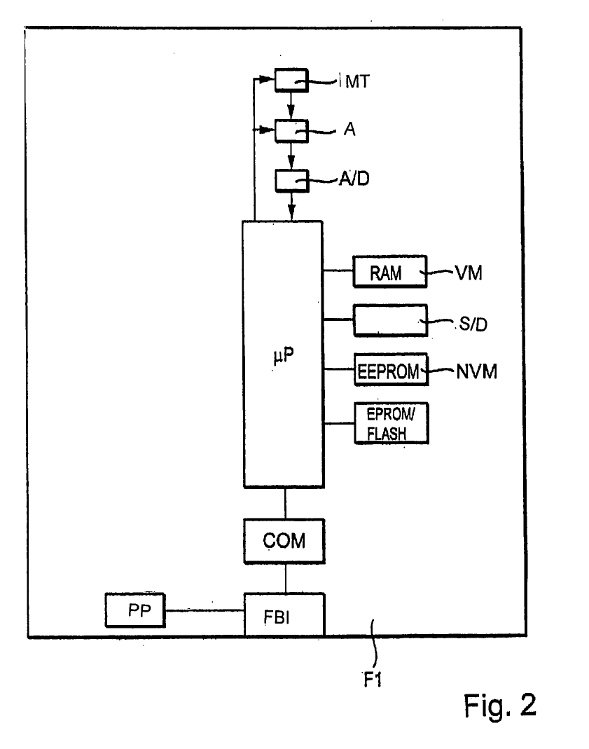

FIG. 2 block diagram of a conventional field device with hardwired data transfer and energy supply via the fieldbus;

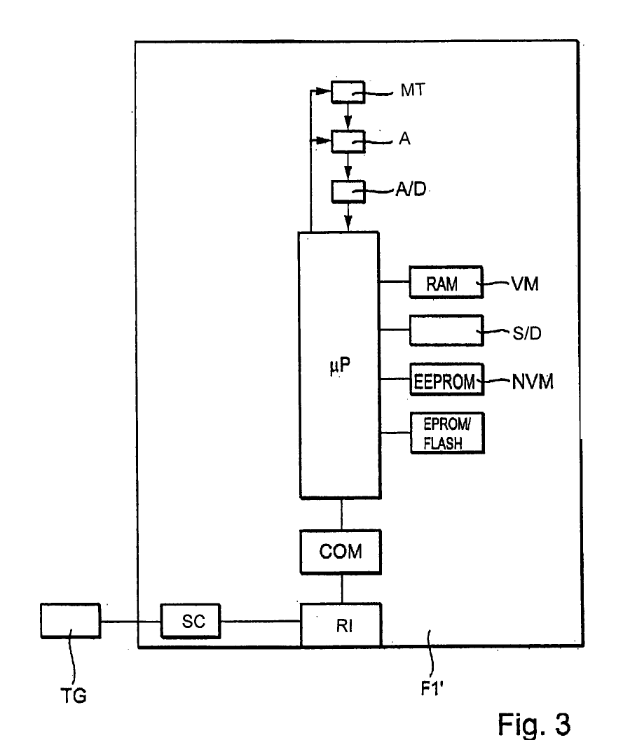

FIG. 3 block diagram of a radio field device with the energy supply of the invention;

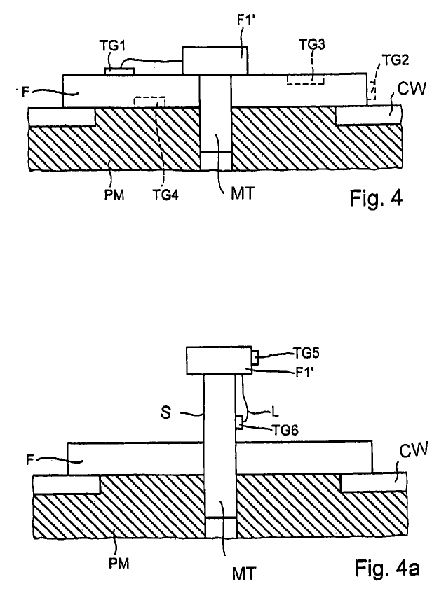

FIG. 4 example of an application of the invention; and

FIG. 4a alternative example of an application of the invention.

FIG. 1 shows a process automation network in greater detail. Connected to a databus D1 are multiple computer units, e.g. workstations WS1, WS2. These computer units serve as superordinated units (control systems or control units) for, among other things, process visualization, process monitoring and engineering, as well as servicing and monitoring field devices. The databus functions e.g. according to the Profibus DP standard, or the HSE (high speed Ethernet) standard of Foundation Fieldbus.

Via a gateway G1, also called a “linking device” or “segment coupler,” databus D1 is connected with a fieldbus segment SM1. Fieldbus segment SM1 is made up of multiple field devices F1, F2, F3, F4, which are connected with one another via a fieldbus FB. The field devices F1, F2, F3, F4 can be sensors or actuators. Fieldbus FB functions according to one of the known fieldbus standards Profibus, Foundation Fieldbus, or HART.

FIG. 2 shows a block diagram of a conventional field device, e.g. F1, in greater detail. For processing measurement values, a microprocessor μP is connected, via an analog-digital converter A/D and an amplifier A, with a measuring transducer MT, which registers a process variable (e.g. pressure, flow rate, or fill level). Microprocessor μP is connected with a plurality of memories. Memory VM serves as a temporary (volatile), working memory, RAM. An additional memory EPROM or flash memory FLASH serves as memory for the control program to be executed in the microprocessor μP. In a non-volatile, writable memory NVM, e.g. an EEPROM memory, parameter values (e.g. calibration data, etc.) are stored.

The control program running in the microprocessor μP defines the application-related functions of the field device (measurement value calculation, envelope curve evaluation, linearizing of measurement values, diagnostic tasks).

Furthermore, the microprocessor μP is connected to a service/display unit S/D (e.g. an LCD display with a plurality of push-buttons).

For communicating with the fieldbus segment SM1, the microprocessor μP is connected with a fieldbus interface FBI via a communication controller COM. A power pack PP supplies the required energy for the individual electronics components of the field device F1. In the illustrated instance, the fieldbus FB delivers the energy required for operating the field device.

For the sake of clarity, lines for supplying energy to the individual components in the field device are not shown.

FIG. 3 shows a block diagram of a radio field device F1′ having an energy supply in accordance with the invention. Construction of field device F1′ essentially corresponds to the assembly of the field device F1 shown in FIG. 2. Unlike the field device F1 shown in FIG. 2, however, field device F1′ has no fieldbus interface, but, instead, a radio interface RI. Via this radio interface, data can be sent from the field device e.g. to superordinated units, or data can be received by the field device from such superordinated units.

Furthermore, the field device F1′ has no power pack PP, but, instead, a supply connection SC, which is connected with a thermogenerator TG via a line L. The thermogenerator TG supplies energy required for operating the field device. For the sake of clarity, the lines from the supply connection to the individual components of the field device are likewise not shown.

FIG. 4 shows a possible example of an application for a field device F1′ having an energy supply in accordance with the invention. Field device F1′ sits on a flange F which serves as a process connection. The measuring transducer MT extends through the flange F into the process medium PM. Typically, the measuring transducer MT is a temperature sensor, e.g. a PT100. Flange F is secured on a container wall CW. FIG. 4 shows several alternative arrangements for thermogenerators. Thermogenerator TG1 is mounted directly on the flange F. All of the other alternative arrangements are shown in dashed lines. As shown, the thermogenerator TG2 is attached to the side of the flange F. It is also conceivable to integrate the thermogenerator directly into the flange. This is shown by thermogenerator TG3. A further alternative is shown by thermogenerator TG4, which is attached to the side of the flange F facing the medium.

FIG. 4a shows a further, alternative embodiment of the invention. In this embodiment, the thermogenerator TG6 is attached to a spacer S, which is provided between the flange F and the housing of the field device F1′. In an additional alternative arrangement, a thermogenerator TG5 can also be provided directly on the housing of the field device F1′.

The functioning of the invention will now be explained once more, in greater detail. The thermogenerator TG delivers the energy required for operating the field device F1′. In such case, the temperature difference that exists between the process medium PM and the environment is exploited. A sufficient temperature difference is supplied e.g. by superheated steam applications, in which steam having a temperature of e.g. 150° C. flows through a section of pipeline.

The energy output of a thermogenerator increases with the size of the temperature difference existing between the upper and lower sides of the thermogenerator. Therefore, suitable arrangement of the thermogenerator is especially important, in order to exploit, optimally, the temperature differences at hand. As shown in FIGS. 4 and 4a, thermogenerators can be provided at different locations, on the process connection or on the housing of the field device.

In an advantageous embodiment of the invention, the thermogenerators are Peltier elements or arrays of micro-Peltier elements. Even in the case of a relatively small surface of a few square centimeters, and an easily achievable temperature difference of 10° K, such arrays deliver a sufficient output of up to a value in the range 50-100 mW, which is adequate for operating a field device.

Obviously, it is also possible to store the energy supplied by the thermogenerator in an energy storage unit (e.g. a Gold-Cup). This extra energy can then be accessed at later points in time.

In order to optimally adjust energy consumption of the field device, an energy control unit is provided, which regulates energy consumption and energy distribution in the field device. This energy control unit is essentially realized by the microprocessor μP, which carries out the control method.

The energy supply of the invention is especially suited to field devices which communicate via radio. It is extremely low-maintenance and very cost-effective.

It is also conceivable that only a part of the energy required for the energy supply of a field device is obtained with the help of thermogenerators. Thus, 4-conductor devices can be converted to 2-conductor devices. In this case, the two lines for energy supply can be omitted. This converted field device corresponds to that shown in FIG. 2, supplemented by the components, thermogenerator plus supply connection.

1-9. (canceled)

10. A method for supplying energy to a field device of automation technology, wherein the field device serves for registering or influencing a chemical and/or physical property of a process medium and is controlled by a microprocessor, comprising the step of:
obtaining the energy required for operating the field device by means of the process medium.

11. The method as claimed in claim 10, wherein:
the energy required for operating the field device is obtained with the help of a thermogenerator, which exploits the temperature differences between the process medium and the environment.

12. The method as claimed in claim 10, wherein:
the energy required for operating the field device is obtained with the help of a thermogenerator, which exploits temperature difference in the process medium.

13. The method as claimed in claim 11, wherein:
the thermogenerator is a Peltier element.

14. The method as claimed in claim 12, wherein:
the Peltier element comprises an array of micro-Peltier elements.

15. The method as claimed in claim 13, an energy storage unit is provided, which serves for intermediate storage of energy delivered by the Peltier element.

16. The method as claimed in claim 10, wherein:
an energy control unit is provided in the field device for controlling energy distribution and energy consumption in the field device.

17. The method as claimed in claim 10, wherein:
the process medium is superheated steam.

18. An apparatus for carrying out a method for supplying energy to a field device of automation technology, comprising:
a databus;
a plurality of workstations connected to said databus;
a fieldbus; and
at least one field device connected to said databus via said fieldbus, wherein said at least one field device has a radio interface by which data can be sent or reserved; and
a thermogenerator which supplies energy to the field device, said thermogenerator exploits the difference between the temperature of the process medium and the ambient temperature of the field device.
